(19) United States
(12) Patent Application Publication
(10) Pub. No.: US 2026/0211570 A1
(43) Pub. Date: Jul. 23, 2026

(54) MEMORY MANAGEMENT METHOD FOR ENHANCING MEMORY RECLAIM EFFICIENCY WITH DEDICATED COMPRESSION UNITS, AND ASSOCIATED APPARATUS

(71) Applicant: MEDIATEK INC., Hsinchu City (TW)

(72) Inventors: Qun-Wei Lin, Hsinchu City (TW); Chin-Wen Chang, Hsinchu City (TW); Chung-Jung Lee, Hsinchu City (TW); Chih-Chiang Yang, Hsinchu City (TW)

(73) Assignee: MEDIATEK INC., Hsinchu City (TW)

(21) Appl. No.: 19/454,412

(22) Filed: Jan. 21, 2026

Related U.S. Application Data
(60) Provisional application No. 63/747,396, filed on Jan. 21, 2025.

(51) Int. Cl. G06F 3/06

(52) U.S. Cl. CPC G06F 3/0644; G06F 3/061; G06F 3/0673

(57) ABSTRACT

A memory management method for enhancing memory reclaim efficiency with dedicated compression units and associated apparatus are provided. The memory management method may include: utilizing the processing circuit to run a memory management module to start performing memory management with a reclaiming architecture of the memory management module, for reducing memory pressure; separately performing page scanning, by a scanning module, and page compression, by the dedicated compression units, the dedicated compression units being configured to individually compress multiple least recently used (LRU) pages and generate compressed data; and storing the compressed data into at least one swap device, and releasing memory space that is previously occupied by the multiple LRU pages.

### CROSS REFERENCE TO RELATED APPLICATIONS

This application claims the benefit of U.S. Provisional Application No. 63/747,396, filed on January 21st, 2025. The content of the application is incorporated herein by reference.

### BACKGROUND

The present invention is related to memory management, and more particularly, to a memory management method for enhancing memory reclaim efficiency with dedicated compression units, and to associated apparatus.

According to the related art, memory reclaiming may be required in a system of an electronic device to maintain free memory space at a high level, in order to keep the whole system healthy. However, some problems may occur. For example, when performing the memory reclaiming, the system may encounter a significant performance bottleneck, especially under high memory pressure. More particularly, there may be a single point of contention, causing delays in memory reclaiming and overall system performance degradation. Thus, a novel method and associated architecture are needed for solving the problems of the related art without introducing any side effect or in a way that is less likely to introduce a side effect.

### SUMMARY

It is an objective of the present invention to provide a memory management method for enhancing memory reclaim efficiency with dedicated compression units, and to provide associated apparatus, in order to solve the above-mentioned problems.

At least one embodiment of the present invention provides a memory management method for enhancing memory reclaim efficiency with dedicated compression units, where the memory management method is applicable to a processing circuit within an electronic device. For example, the memory management method may comprise: utilizing the processing circuit to run a memory management module to start performing memory management with a reclaiming architecture of the memory management module; separately performing page scanning, by a scanning module, and page compression, by the dedicated compression units, the dedicated compression units being configured to individually compress multiple least recently used (LRU) pages and generate compressed data; and storing the compressed data into at least one swap device, and releasing memory space that is previously occupied by the multiple LRU pages.

At least one embodiment of the present invention provides an apparatus that operates according to the memory management method, where the apparatus may comprise at least the processing circuit within the electronic device. According to some embodiments, the apparatus may comprise the whole of the electronic device.

At least one embodiment of the present invention provides a computer-readable medium related to the memory management method, where the computer-readable medium may store a program code which causes the processing circuit to operate according to the memory management method when executed by the processing circuit.

At least one embodiment of the present invention provides an apparatus for enhancing memory reclaim efficiency with dedicated compression units, where the apparatus may comprise a processing circuit that is arranged to control operations of an electronic device when installed within the electronic device. For example, the processing circuit is arranged to run a memory management module to start performing memory management with a reclaiming architecture of the memory management module; the processing circuit separately performs page scanning, by a scanning module, and page compression, by the dedicated compression units, the dedicated compression units being configured to individually compress multiple LRU pages and generate compressed data; and the processing circuit stores the compressed data into at least one swap device, and releases memory space that is previously occupied by the multiple LRU pages.

It is an advantage of the present invention that, through proper design, the proposed method of the present invention, as well as the associated apparatus such as the processing circuit, can achieve a breakthrough in overcoming the significant performance bottleneck mentioned above, and more particularly, can successfully remove the single point of contention, and therefore enhance the overall performance. In addition, the proposed method and the associated apparatus such as the processing circuit can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a memory management control scheme of a memory management method for enhancing memory reclaim efficiency with dedicated compression units according to an embodiment of the present invention.

FIG. 2 illustrates, in the lower half part thereof, a multi-compress control scheme of the memory management method according to an embodiment of the present invention, where a single-compress control scheme may be illustrated in the upper half part of FIG. 2 for better comprehension.

FIG. 3 illustrates some implementation details of the multi-compress control scheme shown in FIG. 2 according to an embodiment of the present invention.

FIG. 4 illustrates a hardware-based compression control scheme of the memory management method according to an embodiment of the present invention.

FIG. 5 illustrates a software-based compression control scheme of the memory management method according to an embodiment of the present invention.

FIG. 6 illustrates a hybrid compression control scheme of the memory management method according to an embodiment of the present invention.

FIG. 7 illustrates a multi-threaded scanning plus multi-threaded compression control scheme of the memory management method according to an embodiment of the present invention.

FIG. 8 illustrates a capacity-aware control scheme of the memory management method according to an embodiment of the present invention.

FIG. 9 is a diagram illustrating an electronic device involved with the memory management method according to an embodiment of the present invention.

FIG. 10 illustrates a working flow of the memory management method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms "include" and "comprise" are used in an open-ended fashion, and thus should be interpreted to mean "include, but not limited to ...". Also, the term "couple" is intended to mean either an indirect or direct electrical connection. Accordingly, if one device is coupled to another device, that connection may be through a direct electrical connection, or through an indirect electrical connection via other devices and connections.

The proposed method can successfully break through the significant performance bottleneck mentioned above. For better comprehension, compressed random-access memory (RAM), abbreviated as ZRAM hereinafter, may refer to a virtual memory which can improve memory efficiency and system performance by providing one or more compressed block devices in a random-access memory (RAM), to allow faster swap operations, increased available memory, and flexible memory management, where the “Z” of the ZRAM may symbolize compression, typically referring to compression algorithms used in the Linux world, as the ZRAM may create the one or more compressed block devices in the RAM to act as a faster swap space, saving physical memory by compressing data before it hits the disk. After enabling the ZRAM, the following issues may occur with a swap module such as a kernel swap daemon (kswapd): (a) Increased Workload, in particular, the kswapd may be forced to manage both page reclamation and compression; and (b) Performance Bottlenecks, for example, the added compression tasks can create bottlenecks, delaying memory reclamation and degrading overall system performance. In an Operating System (OS) such as the Linux system, a kswapd thread may be configured as being responsible for both scanning the LRU pages and compressing pages into the ZRAM. This combined responsibility may lead to significant performance bottlenecks especially under high memory pressure. The kswapd thread may become a single point of contention, causing delays in memory reclaiming and overall system performance degradation. For the case that the context workload of this kswapd thread is heavy, it often cannot meet the large memory requirements. The proposed method can improve the efficiency of memory reclaiming in OSs, for example, by separating the tasks of page scanning and page compression into distinct processes or threads, to allow the system to handle memory pressure more effectively. As this separation can reduce the load on the memory reclaiming process, the proposed method can enhance the overall system performance and the responsiveness under high memory pressure conditions.

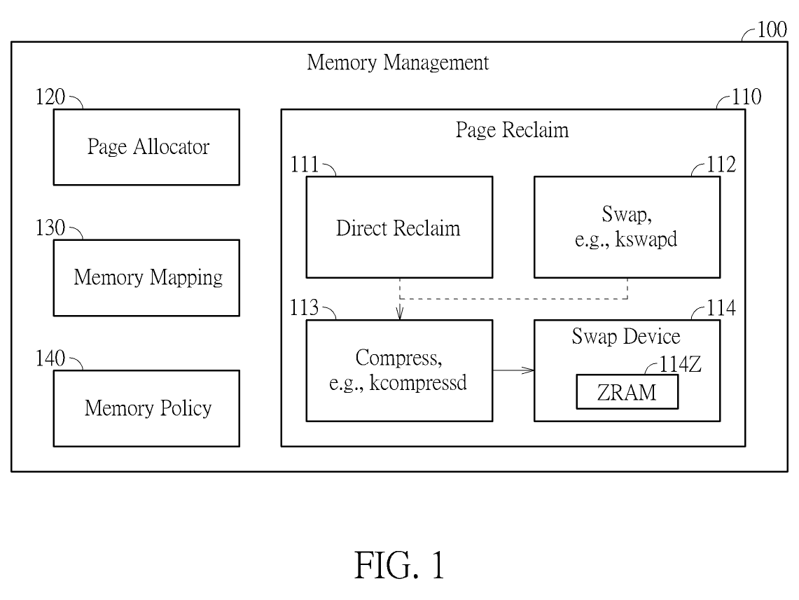

FIG. 1 illustrates a memory management control scheme of a memory management method for enhancing memory reclaim efficiency with dedicated compression units according to an embodiment of the present invention, where the memory management method (referred to as “the method” hereinafter) is applicable to a processing circuit within an electronic device (not shown in FIG. 1). The processing circuit can be arranged to run a Memory Management module 100 (labeled “Memory Management” for brevity) to start performing memory management with a reclaiming architecture of the Memory Management module 100, for reducing the memory pressure. For example, the Memory Management module 100 may comprise multiple program modules such as a Page Reclaim module 110, a Page Allocator module 120, a Memory Mapping module 130 and a Memory Policy module 140 (respectively labeled “Page Reclaim”, “Page Allocator”, “Memory Mapping” and “Memory Policy” for brevity), among which the Page Reclaim module 110 may act as the aforementioned reclaiming architecture of the Memory Management module 100. In addition, the Page Reclaim module 110 may comprise multiple sub-modules such as a Direct Reclaim module 111, a Swap module 112 and a Compress module 113 (respectively labeled “Direct Reclaim”, “Swap” and “Compress” for brevity).

The Page Reclaim module 110, the Page Allocator module 120, the Memory Mapping module 130 and the Memory Policy module 140 can be configured to perform page reclamation, page allocation, memory mapping and memory policy management, respectively, and the Direct Reclaim module 111, the Swap module 112 and the Compress module 113 can be configured to perform direct reclamation, indirect reclamation and compression, respectively. As at least one swap device (e.g., one or more swap devices), collectively referred to as the Swap Device 114, may be accessible by the Page Reclaim module 110 via the corresponding device information (e.g., the device identifier (ID) or the device name), the Swap Device 114 may be illustrated within the Page Reclaim module 110 and/or under one or more sub-modules among the multiple sub-modules thereof, but the present invention is not limited thereto. According to some embodiments, the Swap Device 114 may be illustrated outside the Memory Management module 100, for example, under the Compress module 113. As shown in FIG. 1, the Swap Device 114 may comprise a ZRAM 114Z such as the ZRAM mentioned above. Additionally, the swap device 114 can be used for storage—for example, as part of virtual or physical memory. When the system’s RAM is insufficient, some data (such as memory pages, process states, and so on) is temporarily moved to the swap device 114 so that the system can continue operating.

During performing the memory management with the reclaiming architecture such as the Page Reclaim module 110, the processing circuit can perform page scanning and page compression separately to compress multiple LRU pages into compressed data with the dedicated compression units (e.g., dedicated compression daemons) for reducing the load on the reclaiming architecture such as the Page Reclaim module 110, store the compressed data into the aforementioned at least one swap device such as the Swap Device 114, and release the memory space that is previously occupied by the multiple LRU pages. More particularly, the Memory Management module 100 maybe arranged to act as a subsystem within the OS kernel, where the memory reclaim efficiency represents the OS memory reclaim efficiency of the OS kernel. For the OS such as the Linux system, the OS kernel represents Linux kernel.

As shown in FIG. 1, the reclaiming architecture such as the Page Reclaim module 110 may comprise a first sub-module such as the Swap module 112 and a second sub-module such as the Compress module 113, for performing the page scanning and the page compression, respectively, where the second sub-module such as the Compress module 113 comprises the dedicated compression units. More particularly, the operation of performing the page scanning and the page compression separately as described above may comprise performing the page scanning with the first sub-module such as the Swap module 112 to determine pages that are least recently used among multiple memory pages of a memory within the electronic device as the multiple LRU pages, and performing the page compression with the second sub-module such as the Compress module 113 to share the loading of compressing the multiple LRU pages among the dedicated compression units within the second sub-module such as the Compress module 113.

In the above embodiment, the Swap module 112 can be implemented as a kswapd module, and the Compress module 113 can be implemented as a kernel compress daemon (kcompressd) module, but the present invention is not limited thereto. The Memory Management module 100 can be configured as a subsystem within the Linux kernel that is responsible for managing the memory. In addition, the Page Reclaim module 110 can act as a component within the memory management subsystem that handles the reclamation of page frames. For example, the Direct Reclaim module 111 can be configured to directly reclaim memory resources such as memory pages when a process requests more memory resources than are currently available in the system, and the Swap module 112 such as the kswapd module can be configured to reclaim memory resources such as memory pages in a background manner when the system is under memory pressure, rather than directly in the context of the allocating process. Additionally, the Swap Device 114 can be configured as a storage that is used by the OS to extend the system’s physical memory (e.g., RAM) by providing additional virtual memory.

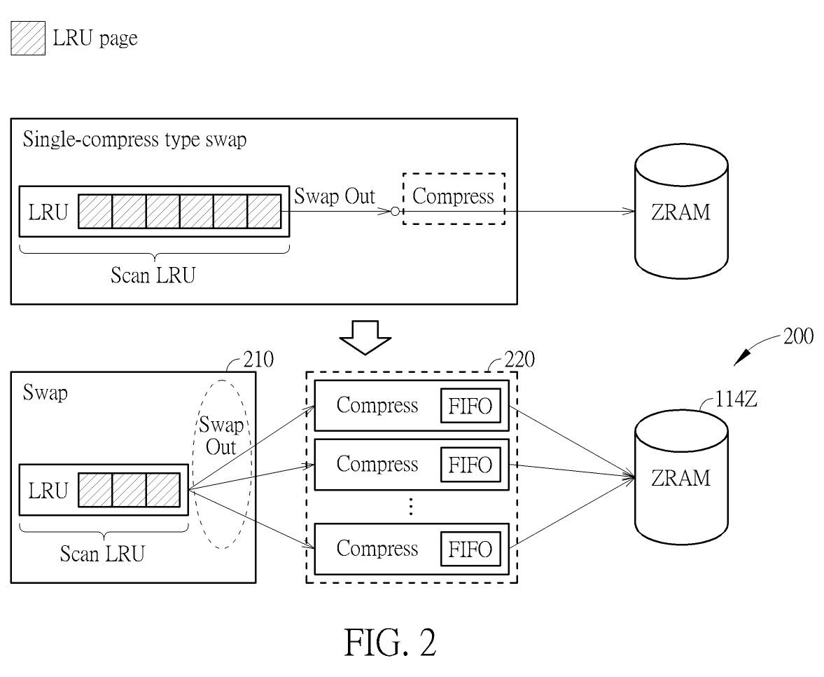

FIG. 2 illustrates, in the lower half part thereof, a multi-compress control scheme of the method according to an embodiment of the present invention, where a single-compress control scheme may be illustrated in the upper half part of FIG. 2 for better comprehension. For example, a swap module implemented based on the single-compress control scheme may be referred to as the single-compress type swap. After enabling the ZRAM, the single-compress type swap may be arranged to scan the LRU pages (labeled “LRU” for brevity) and perform a compress operation (labeled “Compress” for brevity), causing the aforementioned issues such as Increased Workload and Performance Bottlenecks.

Based on the multi-compress control scheme, the page reclaim module 200 comprises multiple sub-modules such as a Swap module 210 (labeled “Swap” for brevity) and a Compress module 220, and the Compress module 220 comprises multiple secondary sub-modules such as multiple Compress sub-modules (labeled “Compress” for brevity) having their own First-In, First-Out (FIFO) buffers (or “the FIFOs”). The Swap module 210 and the Compress module 220 shown in FIG. 2 can be taken as examples of the Swap module 112 and the Compress module 113 shown in FIG. 1, respectively, and the multiple Compress sub-modules within the Compress module 220 can be taken as examples of the dedicated compression units within the Compress module 113. The Swap module 210 can be arranged to scan the LRU pages (labeled “LRU” for brevity), and the Compress module 220 can be arranged to perform multiple compress operations with the multiple Compress sub-modules therein. In this embodiment, the FIFOs may be used for implementing data storage, but the present invention is not limited thereto. According to some embodiments, any memory/buffer capable of storing data in any data structure such as a queue, etc. may be used.

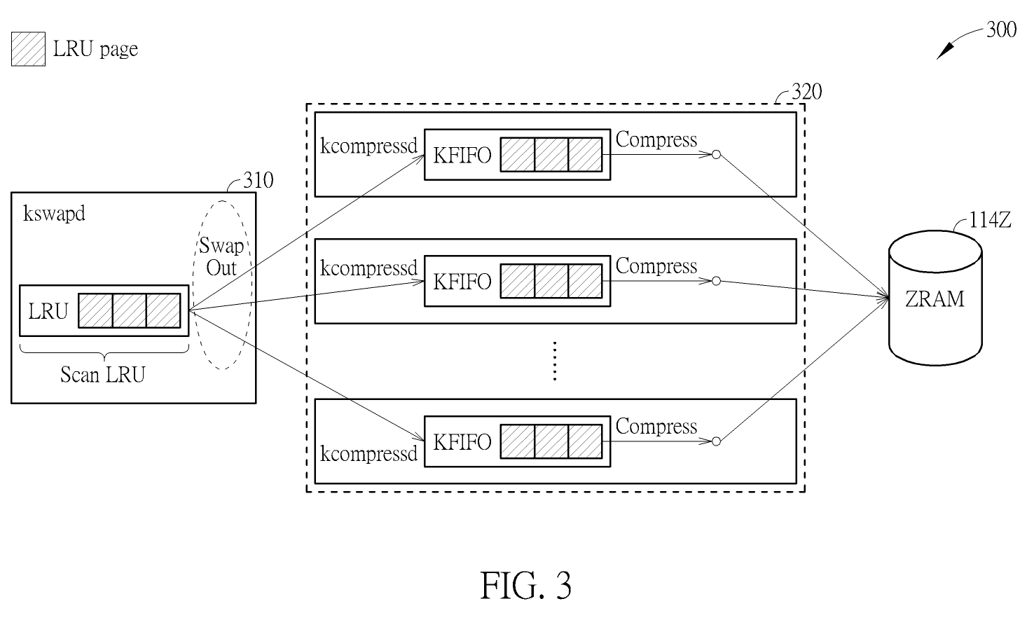

FIG. 3 illustrates some implementation details of the multi-compress control scheme shown in FIG. 2 according to an embodiment of the present invention. The page reclaim module 300 comprises multiple sub-modules such as a kswapd module 310 (labeled “kswapd” for brevity) and a kcompressd module 320, and the kcompressd module 320 comprises multiple secondary sub-modules such as multiple kcompressd sub-modules (labeled “kcompressd” for brevity) having their own kernel FIFOs (labeled “KFIFO” for brevity), where the prefix “k” in “kswapd” and “kcompressd” and the prefix “K” in “KFIFO” denote kernel, and the suffix “d” in “kswapd” and the “kcompressd” denotes daemon. The kswapd module 310 and the kcompressd module 320 shown in FIG. 3 can be taken as examples of the Swap module 210 and the Compress module 220 shown in FIG. 2, respectively, and the multiple kcompressd sub-modules within the kcompressd module 320 can be taken as examples of the multiple Compress sub-modules within the Compress module 220. The multiple kcompressd sub-modules within the kcompressd module 320 can be arranged to perform the multiple compress operations in order to generate the compressed results of the LRU pages (labeled “Compress” for brevity), respectively, for being stored into the ZRAM 114Z. According to this embodiment, the FIFOs such as the KFIFO may be used for implementing data storage, but the present invention is not limited thereto. According to some embodiments, any memory/buffer capable of storing data in any data structure such as a queue, etc. may be used.

In the above embodiment, the multiple kcompressd sub-modules within the kcompressd module 320 can be implemented as multiple dedicated kcompressd threads, but the present invention is not limited thereto. The page reclaim module 300 can be arranged to accelerate the memory reclaiming process by using the multiple kcompressd sub-modules (e.g., the multiple dedicated kcompressd threads), among which each kcompressd sub-modules has its own KFIFO to receive a series of ZRAM compression requests from the kswapd module 310, to allow the system to handle memory pressure more efficiently by distributing the compression workload across the multiple kcompressd sub-modules, thereby reducing the load on the kswapd side and improving the overall system performance. In addition, the multiple kcompressd sub-modules can be implemented by way of software threads like the multiple dedicated kcompressd threads. According to some embodiments, the multiple kcompressd sub-modules can be implemented by way of the use of heterogeneous computing, including but not limited to: hardware ZRAM (HWZRAM), special compression hardware, etc.

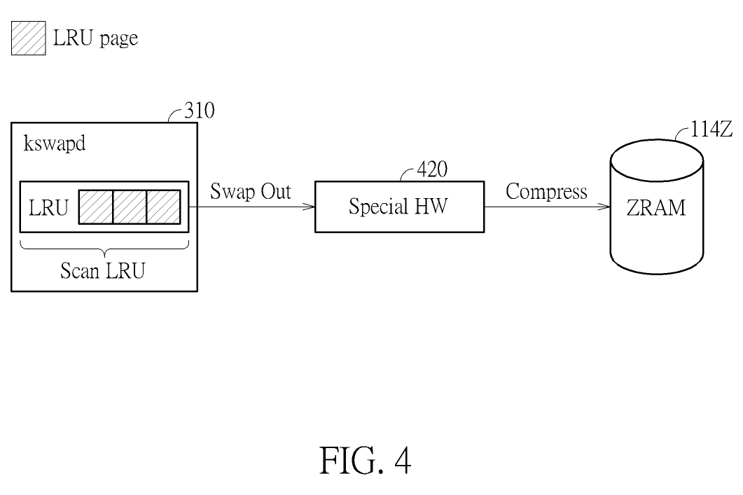

FIG. 4 illustrates a hardware-based compression control scheme of the method according to an embodiment of the present invention. The multiple kcompressd sub-modules within the kcompressd module 320 can be implemented by way of special and/or specialized hardware (HW) circuits, collectively referred to as the Special HW 420, to allow all compression tasks to be handled by the Special HW 420, but the present invention is not limited thereto. For brevity, similar descriptions for this embodiment are not repeated in detail here.

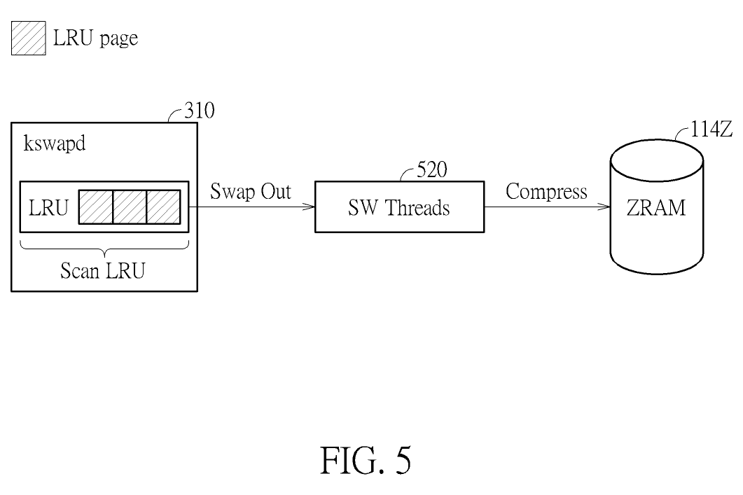

FIG. 5 illustrates a software-based compression control scheme of the method according to an embodiment of the present invention. The multiple kcompressd sub-modules within the kcompressd module 320 can be implemented by way of software (SW) threads 520, to allow all compression tasks to be handled by the SW threads 520, but the present invention is not limited thereto. For brevity, similar descriptions for this embodiment are not repeated in detail here.

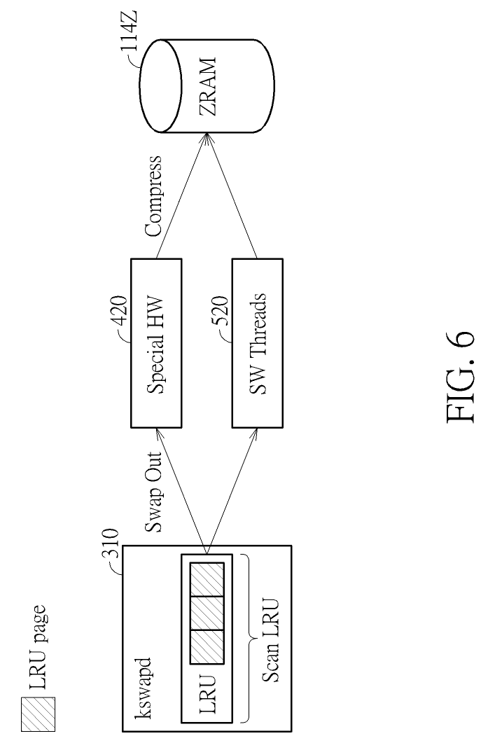

FIG. 6 illustrates a hybrid compression control scheme of the method according to an embodiment of the present invention. The multiple kcompressd sub-modules within the kcompressd module 320 can be implemented by way of the Special HW 420 and the SW threads 520, to allow all compression tasks to be handled by one of or a combination of the Special HW 420 and the SW threads 520. The architecture shown in FIG. 6 can be regarded as the hybrid architecture having both the Special HW 420 and the SW threads 520 mixed therein. For brevity, similar descriptions for this embodiment are not repeated in detail here.

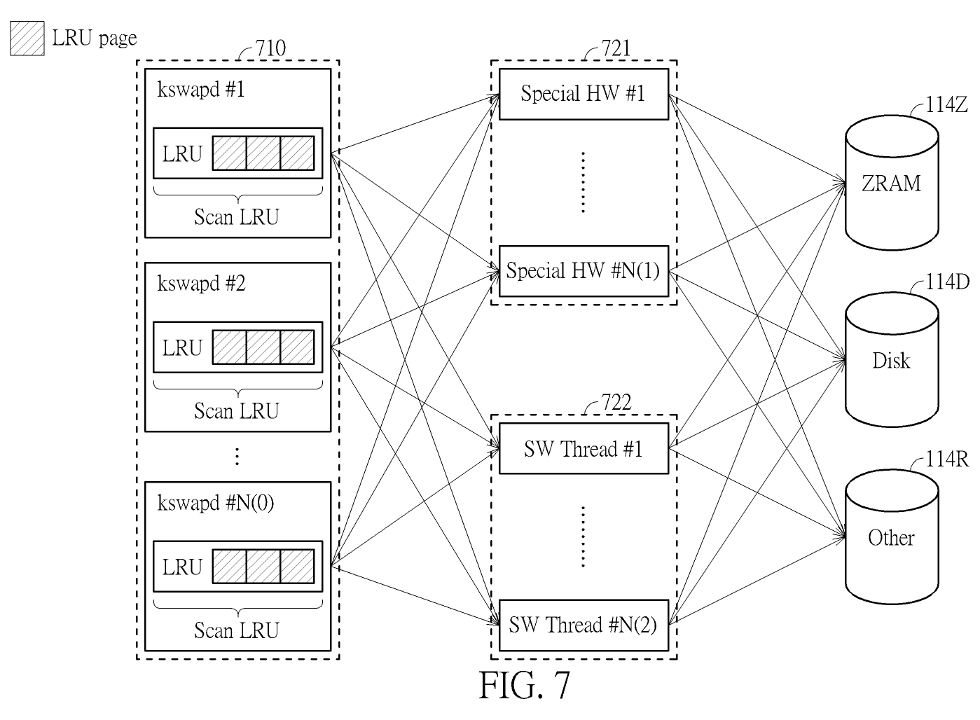

FIG. 7 illustrates a multi-threaded scanning plus multi-threaded compression control scheme of the method according to an embodiment of the present invention. Assuming that “N(0)” may represent a positive integer that is greater than one, the kswapd module 310 within the page reclaim module 300 shown in FIG. 3 can be split into multiple kswapd modules 710 such as N(0) kswapd modules #1, #2, … and #N(0). Assuming that “N(1)” and “N(2)” may represent positive integers that are greater than one, the kcompressd module 320 within the page reclaim module 300 shown in FIG. 3 can be implemented by way of various combinations of the Special HW 420 and the SW threads 520, including but not limited to: multiple Special HW circuits 721 such as N(1) Special HW circuits #1, #2, … and #N(1) (labeled “Special HW” for brevity) as well as multiple SW threads 722 such as N(2) SW threads #1, #2, … and #N(2). In addition, the ZRAM 114Z shown in FIG. 3 can be extended to be various combinations of different swap devices, including but not limited to: the ZRAM 114Z, at least one disk (e.g., one or more disks), collectively referred to as the Disk 114D, and one or more other types of storage devices, collectively referred to as the Other Storage Device 114R (labeled “Other” for brevity). For example, the Disk 114D can be implemented by way of Hard Disk Drive (HDD), Solid-State Drive (SSD), etc. Based on the architecture shown in FIG. 7, the page reclaim module 300 can be arranged to perform multi-threaded scanning plus multi-threaded compression. For brevity, similar descriptions for this embodiment are not repeated in detail here.

According to some embodiments, all components in the architecture shown in FIG. 7 are scalable. For example, any number N among the number N(0) of the kswapd modules 710, the number N(1) of the Special HW circuits 721, and the number N(2) of the SW threads 722 may be a positive integer, without the above limitations of being greater than one. In addition, the aforementioned at least one swap device such as the Swap Device 114 shown in FIG. 1 may comprise the ZRAM 114Z, the Disk 114D and the Other Storage Device 114R. For brevity, similar descriptions for these embodiments are not repeated in detail here.

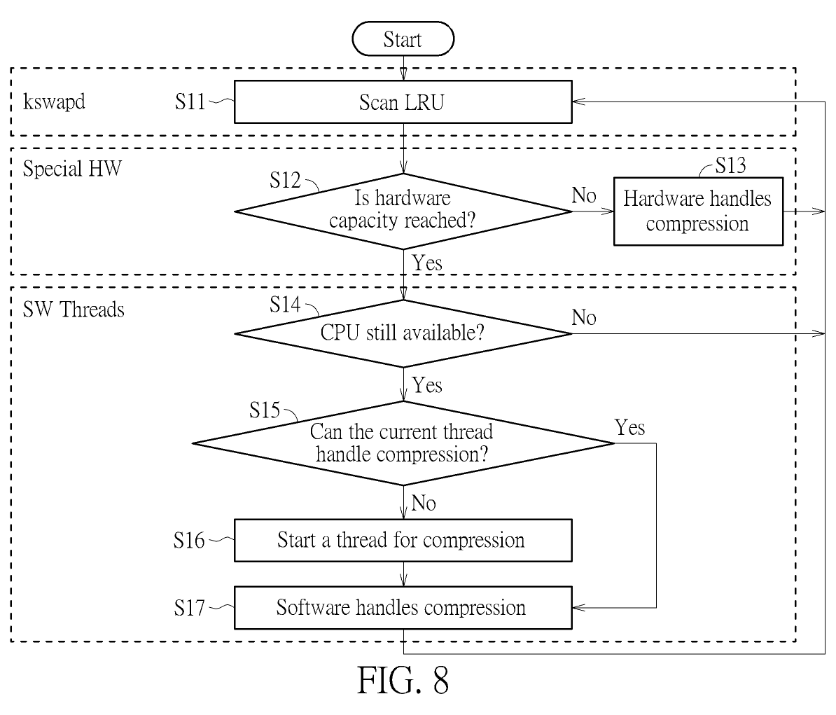

FIG. 8 illustrates a capacity-aware control scheme of the method according to an embodiment of the present invention. The Memory Management module 100 shown in FIG. 1 as well as the Page Reclaim module 110 therein (e.g., the page reclaim module 200 shown in FIG. 2, such as the page reclaim module 300 shown in FIG. 3) can operate according to the capacity-aware control scheme to manage the aforementioned dedicated compression units within the Compress module 113 (e.g., the multiple Compress sub-modules within the Compress module 220 shown in FIG. 2, such as the multiple kcompressd sub-modules within the kcompressd module 320 shown in FIG. 3), in order to enhance the overall system performance.

In Step S11, the Swap module 112 can scan the LRU pages (labeled “LRU” for brevity). For example, when the Swap module 112 is implemented as the kswapd module 310 shown in FIG. 3, the operation of Step S11 can be performed by the kswapd modules 310 (labeled “kswapd” for brevity).

In Step S12, the Page Reclaim module 110 can determine whether hardware capacity is reached. If Yes, Step S14 is entered; if No, Step S13 is entered. For example, when the Compress module 113 such as the kcompressd module 320 is implemented by way of the Special HW 420 and the SW threads 520 as shown in FIG. 6, the hardware capacity mentioned above represents the hardware capacity of the Special HW 420.

In Step S13, under the control of the Page Reclaim module 110 such as the page reclaim module 300, the Special HW 420 can be configured to handle the multiple compress operations (labeled “Hardware handles compression” for brevity). Afterward, Step S11 is entered.

In Step S14, the Page Reclaim module 110 can determine whether the processing circuit such as at least one Central Processing Unit (CPU) still has sufficient calculation resources available for all compress operations (e.g., the multiple compress operations) needing to be performed (labeled “CPU still available” for brevity). If Yes, Step S15 is entered; if No, Step S11 is entered.

In Step S15, the Page Reclaim module 110 such as the page reclaim module 300 can determine whether the current thread among the SW threads 520 can handle the compression. If Yes, Step S17 is entered; if No, Step S16 is entered.

In Step S16, the Page Reclaim module 110 such as the page reclaim module 300 can start a thread as a new thread for the compression, where the new thread can be added into the SW threads 520 to act as a new member of the SW threads 520.

In Step S17, under the control of the Page Reclaim module 110 such as the page reclaim module 300, the SW threads 520 can be configured to handle the multiple compress operations (labeled “Software handles compression” for brevity). Afterward, Step S11 is entered.

As shown in FIG. 8, Steps S12 to S13 and Steps S14 to S17 may correspond to the capacity-aware control of the Special HW 420 and the SW threads 520 (labeled “Special HW” and “SW threads” for brevity), respectively. The Special HW 420 can be configured to handle the compression such as multiple first compression tasks of the page compression until the capacity of the Special HW 420 is reached, and then, after the capacity of the Special HW 420 is reached, the SW threads 520 can be configured to handle multiple remaining compression tasks of the page compression. For example, the SW threads 520 can be configured to comprise a fixed number of software threads that are used for the compression. Under the control of the Page Reclaim module 110 such as the page reclaim module 300, a single software thread among the SW threads 520 can be configured to handle at least one compression task among the multiple remaining compression tasks of the page compression until the capacity of the single software thread is reached, and then a new thread can be started for the additional compression tasks. For brevity, similar descriptions for this embodiment are not repeated in detail here.

For better comprehension, the capacity-aware control scheme may be illustrated with the working flow shown in FIG. 8, but the present invention is not limited thereto. According to some embodiments, one or more steps may be added, deleted, or changed in the working flow shown in FIG. 8. For example, one or more break points may be inserted into this working flow. Regarding a first break point between “Start” and Step S11, before executing Step S11, the Swap module 112 such as the kswapd module 310 can determine whether to perform the indirect reclamation according to whether the free memory space FMS (which may be measured in unit of memory pages, and may be implemented as but not limited to: a number of free memory pages) is less than a first predetermined threshold FMSth1 (e.g., a low watermark for the free memory space FMS). If the free memory space FMS is less than the first predetermined threshold FMSth1, which may indicate that the memory pressure is high, the Swap module 112 can determine that the indirect reclamation should be performed, and therefore Step S11 is entered; otherwise, in a situation where the free memory space FMS is not less than the first predetermined threshold FMSth1, which may indicate that the memory pressure is low, the Swap module 112 can determine that the indirect reclamation should not be performed, and therefore the working flow shown in FIG. 8 comes to the end. Regarding a second break point on a common loop back path from one or more subsequent steps (e.g., Steps S13, S14 and S17) toward Step S11, after at least one loop (e.g., a first loop comprising Steps S11 to S13, a second loop comprising Steps S11, S12 and S14, a third loop comprising Steps S11, S12, S14, S15 and S17, and/or a fourth loop comprising Steps S11, S12 and S14 to S17) in the working flow shown in FIG. 8 has been executed, before executing Step S11, the Swap module 112 such as the kswapd module 310 can determine whether to continue performing the indirect reclamation according to whether the free memory space FMS is less than a second predetermined threshold FMSth2 (e.g., a high watermark for the free memory space FMS), while FMSth2 > FMSth1. If the free memory space FMS is less than the second predetermined threshold FMSth2, the Swap module 112 can determine to continue performing the indirect reclamation, and therefore Step S11 is entered; otherwise, in a situation where the free memory space FMS is not less than the second predetermined threshold FMSth2, the Swap module 112 can determine to stop performing the indirect reclamation, and therefore the working flow shown in FIG. 8 comes to the end. For brevity, similar descriptions for these embodiments are not repeated in detail here.

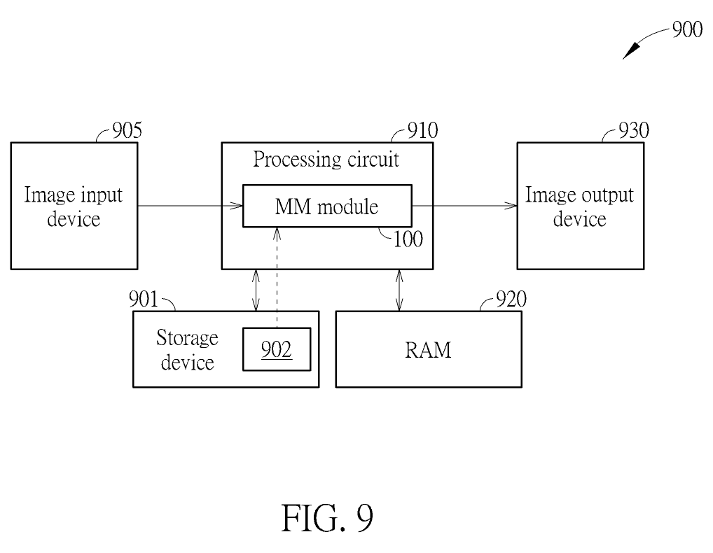

FIG. 9 is a diagram illustrating an electronic device 900 involved with the method according to an embodiment of the present invention. Examples of the electronic device 900 may include, but are not limited to: a personal computer (PC) such as a desktop computer and a laptop computer, a server, an all in one (AIO) computer, a tablet computer and a multifunctional mobile phone as well as a wearable device.

The electronic device 900 may comprise a processing circuit 910 that is capable of running the Memory Management module 100 (labeled “MM module” for brevity), and may further comprise a computer-readable medium such as a storage device 901, an image input device 905, a random access memory (RAM) 920 and an image output device 930. The processing circuit 910 may be arranged to control operations of the electronic device 900. More particularly, the computer-readable medium such as the storage device 901 may be arranged to store a program code 902, for being loaded onto the processing circuit 910 to act as the Memory Management module 100 running on the processing circuit 910. When executed by the processing circuit 910, the program code 902 may cause the processing circuit 910 to operate according to the method, in order to perform the associated operations of the Memory Management module 100. For example, multiple program modules may run on the processing circuit 910 for controlling the operations of the electronic device 900, where the Memory Management module 100 may be one of the multiple program modules, but the present invention is not limited thereto. In addition, the image input device 905 may be arranged to input or receive multiple input images, the RAM 920 may be arranged to temporarily store the multiple input images, the Memory Management module 100 running on the processing circuit 910 may be arranged to process the multiple input images, and more particularly, perform image processing such as image editing on the multiple input images to generate multiple output images, and the image output device 930 may be arranged to output or display the multiple output images, but the present invention is not limited thereto. For example, the RAM 920 may be arranged to temporarily store the multiple input images and the multiple output images, and/or the storage device 901 may be arranged to store the multiple input images and the multiple output images.

In the above embodiment, the storage device 901 can be implemented by way of a hard disk drive (HDD), a solid state drive (SSD) and a non-volatile memory such as a Flash memory, the image input device 905 can be implemented by way of a camera, the processing circuit 910 can be implemented by way of at least one processor, the RAM 920 can be implemented by way of a dynamic random access memory (DRAM), and the image output device 930 can be implemented by way of a display device such as a liquid-crystal display (LCD) panel, an organic light-emitting diode (OLED) panel, etc., where the display device can be implemented as a touch-sensitive panel, but the present invention is not limited thereto. According to some embodiments, the architecture of the electronic device 900 and/or the components therein may vary.

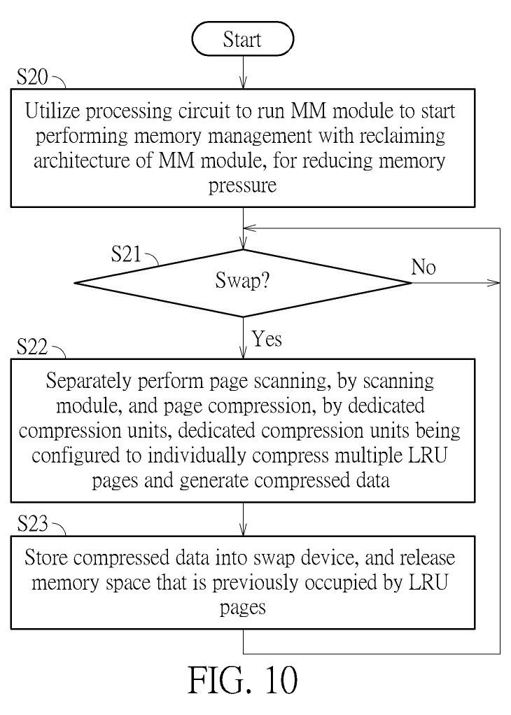

FIG. 10 illustrates a working flow of the method according to an embodiment of the present invention. The method can be applied to the electronic device 900 as well as the processing circuit 910 within the electronic device 900.

In Step S20, the electronic device 900 can utilize the processing circuit 910 to run the Memory Management module 100 (labeled “MM module” for brevity) to start performing the memory management with the reclaiming architecture (e.g., the Page Reclaim module 110) of the Memory Management module 100, for reducing the memory pressure.

In Step S21, the processing circuit 910 (or the Memory Management module 100 running thereon, in particular, the Swap module 112 in the Page Reclaim module 110) can determine whether to perform the indirect reclamation (or “the indirect reclaim”), including but not limited to a swap operation (labeled “Swap” for brevity). If Yes, Step S22 is entered; if No, Step S20 is entered.

In Step S22, the processing circuit 910 (or the Memory Management module 100 running thereon, in particular, the Page Reclaim module 110) can separately perform page scanning, by a scanning module, and page compression, by the dedicated compression units, the dedicated compression units being configured to individually compress multiple least recently used (LRU) pages and generate compressed data. The reclaiming architecture mentioned in Step S20, such as the Page Reclaim module 110 shown in FIG. 1, may comprise the first sub-module such as the Swap module 112 and the second sub-module such as the Compress module 113, for performing the page scanning and the page compression, respectively, where the scanning module may represent the first sub-module such as the Swap module 112, and the second sub-module such as the Compress module 113 may comprise the dedicated compression units.

In Step S23, the processing circuit 910 (or the Memory Management module 100 running thereon, in particular, the Page Reclaim module 110) can store the compressed data into the aforementioned at least one swap device such as the Swap Device 114, and release the memory space that is previously occupied by the multiple LRU pages.

Said separation of scanning and compression, and distribution of compression tasks among the dedicated compression units, minimises the processing workload assigned to the reclaiming architecture and improves system responsiveness under high memory pressure conditions. During performing the memory management with the reclaiming architecture such as the Page Reclaim module 110, the processing circuit 910 (or the Memory Management module 100 running thereon, in particular, the Page Reclaim module 110) can perform the page scanning and the page compression separately to compress the multiple LRU pages into the compressed data with the dedicated compression units (e.g., the dedicated compression daemons) for reducing the load on the reclaiming architecture such as the Page Reclaim module 110, store the compressed data into the aforementioned at least one swap device such as the Swap Device 114, and release the memory space that is previously occupied by the multiple LRU pages.

The reclaiming architecture such as the Page Reclaim module 110 (e.g., the page reclaim module 300 shown in FIG. 3) can be configured to distribute the compression workload of the page compression across the dedicated compression units (e.g., the multiple kcompressd sub-modules within the kcompressd module 320), rather than putting the compression workload onto the Swap module 112 (e.g., the kswapd module 310), in order to enhance the memory reclaim efficiency and improve the system performance and the responsiveness under high memory pressure, where the load on the reclaiming architecture comprises the compression workload. For example, the dedicated compression units can be implemented by way of one of or a combination of hardware circuits (e.g., the Special HW 420) and software threads (e.g., the SW threads 520). For brevity, similar descriptions for this embodiment are not repeated in detail here.

For better comprehension, the method may be illustrated with the working flow shown in FIG. 10, but the present invention is not limited thereto. According to some embodiments, one or more steps may be added, deleted, or changed in the working flow shown in FIG. 10. For example, the processing circuit 910 (or the Memory Management module 100 running thereon, in particular, the Direct Reclaim module 111 in the Page Reclaim module 110) can determine whether to perform the direct reclamation (or “the direct reclaim”). When the page‑allocation path of the task needs memory and the free memory space FMS is insufficient for the need, the Direct Reclaim module 111 can perform the direct reclamation synchronously in the page‑allocation path of the task that needs memory. In addition, the Swap module 112 can run in the background to monitor the free memory space FMS in order to selectively perform the indirect reclamation. For example, before starting performing the indirect reclamation, the Swap module 112 can determine whether to perform the indirect reclamation according to whether the free memory space FMS is less than the first predetermined threshold FMSth1. If the free memory space FMS is less than the first predetermined threshold FMSth1, which may indicate that the memory pressure is high, the Swap module 112 determines that the indirect reclamation should be performed, and therefore Step S22 is entered; otherwise, in a situation where the free memory space FMS is not less than the first predetermined threshold FMSth1, which may indicate that the memory pressure is low, the Swap module 112 determines that the indirect reclamation should not be performed, and therefore Step S21 is entered. During performing the indirect reclamation, the Swap module 112 can determine whether to continue performing the indirect reclamation according to whether the free memory space FMS is less than the second predetermined threshold FMSth2. If the free memory space FMS is less than the second predetermined threshold FMSth2, which may indicate that the free memory space FMS is insufficient, the Swap module 112 can determine to continue performing the indirect reclamation, and therefore Step S22 is entered; otherwise, in a situation where the free memory space FMS is not less than the second predetermined threshold FMSth2, which may indicate that the free memory space FMS is sufficient, the Swap module 112 can determine to stop performing the indirect reclamation, and therefore Step S21 is entered. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A memory management method for enhancing memory reclaim efficiency with dedicated compression units, the memory management method being applicable to a processing circuit within an electronic device, the memory management method comprising:
utilizing the processing circuit to run a memory management module to start performing memory management with a reclaiming architecture of the memory management module;
separately performing page scanning, by a scanning module, and page compression, by the dedicated compression units, the dedicated compression units being configured to individually compress multiple least recently used (LRU) pages and generate compressed data; and
storing the compressed data into at least one swap device, and releasing memory space that is previously occupied by the multiple LRU pages.

2. The memory management method of claim 1, wherein the memory management module is arranged to act as a subsystem within an operating system (OS) kernel, wherein the memory reclaim efficiency represents OS memory reclaim efficiency of the OS kernel.

3. The memory management method of claim 2, wherein the OS kernel represents a Linux kernel.

4. The memory management method of claim 1, wherein the reclaiming architecture comprises a first sub-module and a second sub-module for performing the page scanning and the page compression, respectively, wherein the scanning module represents the first sub-module, and the second sub-module comprises the dedicated compression units.

5. The memory management method of claim 4, wherein separately performing the page scanning and the page compression further comprises:
performing the page scanning with the first sub-module to determine pages that are least recently used among multiple memory pages of a memory within the electronic device as the multiple LRU pages; and
performing the page compression with the second sub-module to share loading of compressing the multiple LRU pages among the dedicated compression units within the second sub-module.

6. The memory management method of claim 4, wherein the reclaiming architecture is configured to distribute compression workload of the page compression across the dedicated compression units, rather than putting the compression workload onto the first sub-module, wherein the load on the reclaiming architecture comprises compression workload.

7. The memory management method of claim 1, wherein the dedicated compression units are implemented by way of one of or a combination of multiple hardware circuits and multiple software threads.

8. The memory management method of claim 7, wherein the multiple hardware circuits are configured to handle multiple first compression tasks of the page compression until capacity of the multiple hardware circuits is reached.

9. The memory management method of claim 8, wherein after the capacity of the multiple hardware circuits is reached, the multiple software threads are configured to handle multiple remaining compression tasks of the page compression.

10. The memory management method of claim 9, wherein a single software thread among the multiple software threads is configured to handle at least one compression task among the multiple remaining compression tasks of the page compression until capacity of the single software thread is reached.

11. An apparatus for enhancing memory reclaim efficiency with dedicated compression units, the apparatus comprising:
a processing circuit, arranged to control operations of an electronic device when installed within the electronic device;
wherein:
the processing circuit is arranged to run a memory management module to start performing memory management with a reclaiming architecture of the memory management module;
the processing circuit separately performs page scanning, by a scanning module, and page compression, by the dedicated compression units, the dedicated compression units being configured to individually compress multiple least recently used (LRU) pages and generate compressed data; and
the processing circuit stores the compressed data into at least one swap device, and releases memory space that is previously occupied by the multiple LRU pages.

12. The apparatus of claim 11, wherein the memory management module is arranged to act as a subsystem within an operating system (OS) kernel, wherein the memory reclaim efficiency represents OS memory reclaim efficiency of the OS kernel.

13. The apparatus of claim 12, wherein the OS kernel represents a Linux kernel.

14. The apparatus of claim 11, wherein the reclaiming architecture comprises a first sub-module and a second sub-module for performing the page scanning and the page compression, respectively, wherein the scanning module represents the first sub-module, and the second sub-module comprises the dedicated compression units.

15. The apparatus of claim 14, wherein during separately performing the page scanning and the page compression, the processing circuit performs the page scanning with the first sub-module to determine pages that are least recently used among multiple memory pages of a memory within the electronic device as the multiple LRU pages, and performs the page compression with the second sub-module to share loading of compressing the multiple LRU pages among the dedicated compression units within the second sub-module.

16. The apparatus of claim 14, wherein the reclaiming architecture is configured to distribute compression workload of the page compression across the dedicated compression units, rather than putting the compression workload onto the first sub-module, wherein the load on the reclaiming architecture comprises compression workload.

17. The apparatus of claim 11, wherein the dedicated compression units are implemented by way of one of or a combination of multiple hardware circuits and multiple software threads.

18. The apparatus of claim 17, wherein the multiple hardware circuits are configured to handle multiple first compression tasks of the page compression until capacity of the multiple hardware circuits is reached.

19. The apparatus of claim 18, wherein after the capacity of the multiple hardware circuits is reached, the multiple software threads are configured to handle multiple remaining compression tasks of the page compression.

20. The apparatus of claim 19, wherein a single software thread among the multiple software threads is configured to handle at least one compression task among the multiple remaining compression tasks of the page compression until capacity of the single software thread is reached.
